(19) United States
(12) Patent Application Publication
(10) Pub. No.: US 2026/0310421 A1
(43) Pub. Date: Oct. 8, 2026

(54) INFORMATION DISPLAY METHOD, APPARATUS, MEDIUM, ELECTRONIC DEVICE AND STORAGE MEDIUM

(71) Applicant: Beijing Zitiao Network Technology Co., Ltd., Beijing (CN)

(72) Inventors: Wenchao LI, Beijing (CN); Yinghao WANG, Beijing (CN); Yifang BAO, Beijing (CN); Peng ZHOU, Beijing (CN)

(21) Appl. No.: 19/573,778

(22) Filed: Mar. 20, 2026

(30) Foreign Application Priority Data
Apr. 7, 2025 (CN) 202510429614.X

(51) Int. Cl. G06F 8/33

(52) U.S. Cl. CPC G06F 8/33

(57) ABSTRACT

An information display method and apparatus, a medium, an electronic device and a storage medium, which relate to the field of computer technologies. The method includes: displaying a code editing page, where the code editing page is used to edit a code file; and displaying first prompt information in response to a code editing operation for the code file, where the first prompt information includes recommended code for target text in the code file and a target natural language text corresponding to the recommended code, the recommended code is generated by an agent, and the target natural language text is used to represent a summary of the recommended code generated by the agent.

### CROSS-REFERENCE TO RELATED APPLICATION(S)

This application claims priority to Chinese Application No. 202510429614.X filed Apr. 07, 2025, the disclosure of which is incorporated herein by reference in its entirety.

### TECHNICAL FIELD

The present disclosure relates to the field of computer technology, and in particular, to an information display method, an information display apparatus, a medium, an electronic device and a storage medium.

### BACKGROUND

Code is a source file written by a developer in a language supported by a development tool, and is a set of explicit rule systems that represent information in a discrete form by characters, symbols or signal code elements. The code is an important basis for implementing services. In a code development scenario, the developer needs to manually edit the code, and the efficiency of code editing in the entire code development process is low.

### SUMMARY

The Summary section is provided to introduce ideas in a brief form, which will be described in detail later in the Detailed Description of Embodiments section. This Summary is not intended to identify key features or essential features of the claimed technical solution, nor is it intended to limit the scope of the claimed technical solution.

In a first aspect, the present disclosure provides an information display method, including:

displaying a code editing page, where the code editing page is used to edit a code file; and

displaying first prompt information in response to a code editing operation for the code file, where the first prompt information includes recommended code for target text in the code file and a target natural language text corresponding to the recommended code, the recommended code is generated by an agent, and the target natural language text is used to represent a summary of the recommended code generated by the agent.

In a second aspect, the present disclosure provides an information display apparatus, including:

a first display module, configured to display a code editing page, where the code editing page is used to edit a code file; and

a second display module, configured to display first prompt information in response to a code editing operation for the code file, where the first prompt information includes recommended code for target text in the code file and a target natural language text corresponding to the recommended code, the recommended code is generated by an agent, and the target natural language text is used to represent a summary of the recommended code generated by the agent.

In a third aspect, the present disclosure provides a computer-readable medium, having a computer program stored thereon, where the computer program, when executed by a processing apparatus, implements the steps of the method according to the first aspect.

In a fourth aspect, the present disclosure provides an electronic device, including:

a storage, having a computer program stored thereon; and

a processing apparatus, configured to execute the computer program in the storage to implement the steps of the method according to the first aspect.

In a fifth aspect, the present disclosure provides a computer program product, including a computer program, where the computer program, when executed by a processor, implements the steps of the method according to the first aspect.

Other features and advantages of the present disclosure will be described in detail in the following section Detailed Description of Embodiments.

### BRIEF DESCRIPTION OF THE DRAWINGS

The above and other features, advantages and aspects of the embodiments of the present disclosure will become more apparent when taken in conjunction with the drawings and with reference to the following detailed description. Throughout the Drawings, the same or similar reference numbers refer to the same or similar elements. It should be understood that the Drawings are schematic and that the components and elements are not necessarily drawn to scale. In the Drawings:

FIG. 1 is a flowchart of an information display method according to an embodiment of the present disclosure;

FIG. 2 is a schematic diagram of a code editing page in a continuation scenario according to an embodiment of the present disclosure;

FIG. 3 is a schematic diagram of a line indication identifier according to an embodiment of the present disclosure;

FIG. 4 is a schematic diagram of a code editing page according to an embodiment of the present disclosure;

FIG. 5 is a schematic diagram of a code editing page according to an embodiment of the present disclosure;

FIG. 6 is a schematic diagram of a code editing page according to an embodiment of the present disclosure;

FIG. 7 is a schematic diagram of a code editing page according to an embodiment of the present disclosure;

FIG. 8 is a schematic diagram of a code editing page according to an embodiment of the present disclosure;

FIG. 9 is a schematic diagram of a code editing page according to an embodiment of the present disclosure;

FIG. 10 is a schematic diagram of a code editing page according to an embodiment of the present disclosure;

FIG. 11 is a block diagram of an information display apparatus according to an embodiment of the present disclosure; and

FIG. 12 is a schematic structural diagram of an electronic device according to an embodiment of the present disclosure.

### DETAILED DESCRIPTION OF EMBODIMENTS

The embodiments of the present disclosure will be described in more detail below with reference to the drawings. Although some embodiments of the present disclosure are shown in the Drawings, it should be understood that the present disclosure may be implemented in various forms, and should not be interpreted as limited to the embodiments set forth herein. Instead, these embodiments are provided for a more thorough and complete understanding of the present disclosure. It should be understood that the drawings and embodiments of the present disclosure are only for exemplary purposes, and are not intended to limit the protection scope of the present disclosure.

It should be understood that the various steps described in the method implementations of the present disclosure may be executed in different orders and/or in parallel. Furthermore, the method implementations may include additional steps and/or omit the execution of the steps shown. The scope of the present disclosure is not limited in this regard.

As used herein, the term “include/comprise” and its variations are open-ended inclusions, that is, “include/comprise but not limited to”. The term “based on” is “based at least in part on”. The term “an embodiment” means “at least one embodiment”; the term “another embodiment” means “at least one other embodiment”; the term “some embodiments” means “at least some embodiments”. Relevant definitions of other terms will be given in the following description.

It should be noted that the concepts of “first”, “second”, etc. mentioned in the present disclosure are only used to distinguish different apparatuses, modules or units, and are not used to limit the order or interdependence of the functions performed by these apparatuses, modules or units.

It should be noted that the modifications of “a”, “an” and “a plurality of” mentioned in the present disclosure are illustrative rather than restrictive. Those skilled in the art should understand that unless otherwise explicitly specified in the context, they should be understood as “one or more”.

The names of messages or information exchanged between multiple apparatuses in the implementations of the present disclosure are for illustrative purposes only, and are not intended to limit the scope of these messages or information.

It may be understood that before using the technical solutions disclosed in the embodiments of the present disclosure, the user should be informed of the type, range of use, use scenarios, etc. of personal information involved in the present disclosure in an appropriate manner in accordance with relevant laws and regulations, and the authorization of the user should be obtained.

For example, in response to receiving an active request from a user, prompt information is sent to the user to clearly prompt the user that the requested operation will require access to and use of the user’s personal information. In this way, the user may independently choose, based on the prompt information, whether to provide personal information to software or hardware, such as an electronic device, an application, a server or a storage medium, that performs the operations of the technical solutions of the present disclosure.

As an optional but non-limiting implementation, in response to receiving the active request from the user, the manner of sending the prompt information to the user, for example, may be the manner of a pop-up window, and the prompt information may be presented in the pop-up window in text. In addition, the pop-up window may also carry a selection control for the user to select “agree” or “disagree” to provide personal information to the electronic device.

It may be understood that the above process of notifying and acquiring user authorization is only illustrative, and does not constitute a limitation on the implementations of the present disclosure. Other manners that satisfy relevant laws and regulations may also be applied to the implementations of the present disclosure.

At the same time, it may be understood that the data involved in the technical solution (including but not limited to the data itself, the acquisition or use of the data) should comply with requirements of corresponding laws, regulations and related provisions.

In related technologies, in order to simplify the code development process, intelligent code assistance has gradually begun to be used to assist developers in code development. However, in this process, developers still need to spend a long time understanding the recommended intelligent code, which affects the development efficiency.

FIG. 1 is a flowchart of an information display method according to an embodiment of the present disclosure. The information display method may be applied to an electronic device, and the information display method may be executed by an information display apparatus, where the information display apparatus may be implemented by software and/or hardware, and the software and/or hardware may be configured in the electronic device. Referring to FIG. 1, the information display method may include step 110 and step 120.

In step 110, a code editing page is displayed, where the code editing page is used to edit a code file.

In step 120, first prompt information is displayed in response to a code editing operation for the code file, where the first prompt information includes recommended code for target text in the code file and a target natural language text corresponding to the recommended code, the recommended code is generated by an agent, and the target natural language text is used to represent a summary of the recommended code generated by the agent.

Herein, the code editing page may be a page provided by a code editor, and the code editor is used to support a user to develop code, so as to obtain a developed code file.

Herein, the target text may be the code in the code file predicted by the agent that needs to be modified (that is, original code in the code file), or the code in the code file predicted by the agent that needs to be continued (that is, original code in the code file), or the comment text input by the user in the code file.

It may be understood that the code is different from the comment text. The code will be executed by a compiler or an interpreter to implement the logic represented by the code, while the comment text is text content in the code file that is used to explain the function of the code or providing additional information, and will not be executed by the compiler or the interpreter. The main purpose of comments is to improve the readability and maintainability of the code.

Herein, the recommended code may be generated by the agent based on the context of the code file, and the agent may be a product connected to a machine learning model. As an example, the machine learning model may be a large language model, or other neural network models, which is not limited by the present disclosure.

Herein, the summary of the recommended code may describe the reason for providing the recommended code and the encoding logic of the agent for constructing the recommended code, etc. It should be noted that the code is the basis for implementing the functions provided by the services. The more complex the function, the more complex the corresponding code, and the more difficult it is for the user to understand the pure code. Therefore, by using natural language to describe the reason for automatically providing the recommended code for the user and the logical process of the agent for constructing the recommended code, the developer may understand the reason for code modification and quickly understand the encoding logic of the recommended code.

Herein, the first prompt information is displayed on the code editing page, and for the display manner of the first prompt information, reference may be made to the relevant embodiments described below, which will not be repeated in this embodiment. The display manner includes a display style, and a display position, etc.

For the explanation and description of the code editing operation, reference may be made to the relevant embodiments described below, which will not be repeated in this embodiment.

Through the above manner, because the target natural language text is used to represent the summary of the recommended code generated by the agent, the user may quickly understand the recommended code through the target natural language text, so as to reduce the time cost of accepting or rejecting the recommended code, thereby improving the development efficiency of the code file.

In some embodiments, the recommended code and the target text may be highlighted on the code editing page to improve readability. As an example, the manner of highlighting may be to display the recommended code and the target text in bold. It may be understood that other manners of highlighting are still applicable to this embodiment.

In some embodiments, the code editing operation may refer to the operation where the user inputs code in the code file, and the code input by the user may serves as the target text. As an example, upon detecting that the user inputs the code, the agent may predict continuation code for the input code (that is, the target text) for the user, and such continuation code serves as the recommended code for the target text. Hereinafter, the code editing scenario corresponding to this embodiment is referred to as a “continuation scenario” for short.

In some embodiments, in the continuation scenario, the recommended code may be embedded and displayed in the code file in a preset style. Further, the preset style is different from the display style of the target text, so as to facilitate the user to distinguish the recommended code from the original code in the code file. As an example, the preset style may be a style of gray font.

In some embodiments, in the continuation scenario, the recommended code is embedded and displayed in the code file, and further, the target natural language text corresponding to the recommended code may be displayed side by side with the target text. It should be noted that in the modification scenario, the code line where the target text is located is the position of the visual focus. The visual focus helps the user concentrate their attention on a specific area or target in the code editing page.

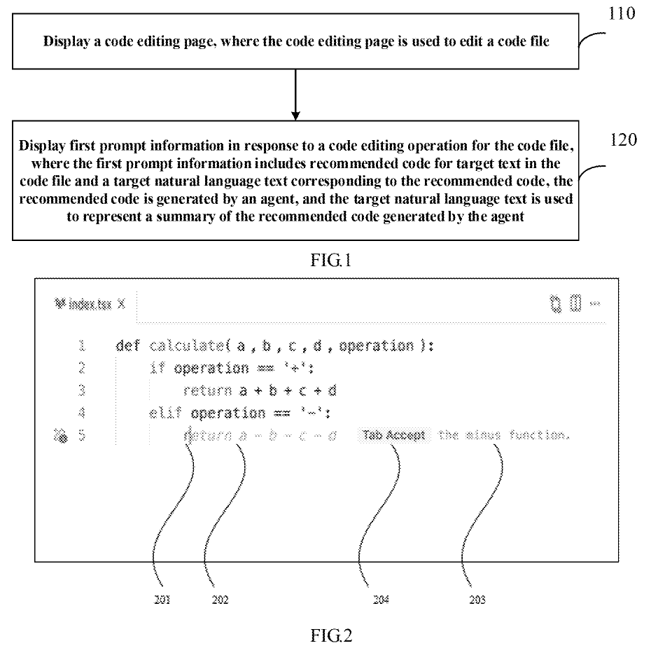

Taking the continuation scenario as an example, FIG. 2 is a schematic diagram of a code editing page in a continuation scenario according to an embodiment of the present disclosure. In FIG. 2, the user inputs the input code 201 (that is, the target text) in the code file, and then the agent generates the recommended code 202 and the target natural language text 203. The recommended code 202 is embedded and displayed in a line of the code file, and the input code 201 and the target natural language text 203 are displayed side by side.

In addition, in the code development scenario, the position of each piece of original code in the code file may be identified by the line number of the code line. The recommended code in the continuation scenario may include a plurality of lines of code, but the user does not necessarily accept the recommendation from the agent. Therefore, in order to distinguish the target text from the recommended code, when the recommended code is embedded and displayed in the code file, it is not necessary to configure a line number representing the position for the recommended code.

In some embodiments, the code editing operation may refer to the operation where the user modifies code in the code file, for example, an operation of modifying the name of a certain parameter. As an example, when detecting that the user modifies code in the code file, the agent may predict code associated with the modified code for the user. It may be understood that the associated code is code in the code file that needs to be modified, and the associated code serves as the target text. Hereinafter, the code editing scenario corresponding to this embodiment is referred to as a modification scenario for short.

In some embodiments, in the modification scenario, the target natural language text corresponding to the recommended code may be displayed side by side with the initial line of code of the target text.

In some embodiments, in the modification scenario, the recommended code may be displayed on the code editing page in the form of a pop-up window.

In some embodiments, the first prompt information further includes a line indication identifier, and the line indication identifier is used to identify the position of the target text in the code file. In this case, the above information display method may further include: displaying state information of the line indication identifier, where the state information is used to represent a current state of the recommended code.

Herein, the line indication identifier may identify the position of the initial line of code of the target text in the code file. As an example, the line indication identifier may be displayed at the line number of the code line where the initial line of code of the target text is located.

Herein, the state information may include any of the generation state, recommendation state, accepted state and jump state. When the recommended code is generated by the agent, the state information may be in the generation state; before the recommended code is successfully applied in the code file and the recommended code has been displayed on the code editing page, the state information may be in the recommendation state; after the recommended code is successfully applied in the code file, the state information may be in the accepted state; for the explanation of the application of the recommended code and the jump state in the code file, reference may be made to the relevant embodiments described below, which will not be repeated in this embodiment.

Through the above manner, the user is provided with the current state of the recommended code by displaying the state information of the line indication identifier.

In some embodiments, after an operation of applying the recommended code in the code file is triggered, the line indication identifier is further used to identify the position of the recommended code in the code file.

The position of the recommended code in the code file may be represented by the line number of the code line. Therefore, the line indication identifier may be used, after the recommended code is applied, to identify the range of the line numbers of the code lines associated with the recommended code in the code file, thereby identifying the position of the recommended code in the code file.

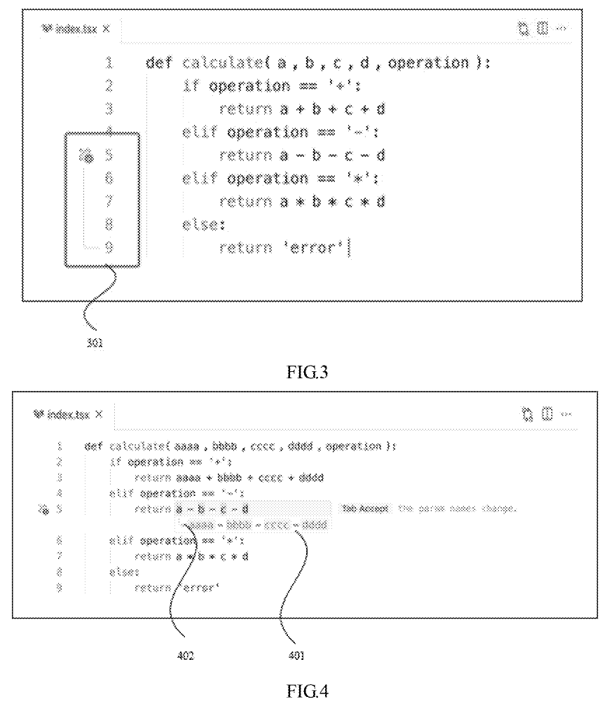

FIG. 3 is a schematic diagram of a line indication identifier according to an embodiment of the present disclosure. Referring to FIG. 3, a target box 301 illustrates identifying the position of the recommended code in the code file through the line indication identifier.

It may be seen from the above that the recommended code may include multiple lines, and before the operation of applying the recommended code in the code file is triggered, the line indication identifier may only identify the position of the target text in the code file. Therefore, after the operation of applying the recommended code in the code file is triggered, the user cannot obtain the range involved in the code modified this time.

Therefore, through the above manner, after the operation of applying the recommended code in the code file is triggered, the line indication identifier may be used to identify the position of the recommended code in the code file for the user. In addition, in this embodiment, for the operation of triggering the application of the recommended code in the code file, reference may be made to the relevant embodiments described below, which will not be repeated in this embodiment.

In some embodiments, in the modification scenario, the target text is original code in the code file, and the target text is single-line code, the recommended code includes replacement fragments corresponding to multiple code fragments that need to be replaced in the target text, and the recommended code is displayed below the target text.

FIG. 4 is a schematic diagram of a code editing page according to an embodiment of the present disclosure. Referring to FIG. 4, the recommended code 401 includes replacement fragments corresponding to a plurality of code fragments to be replaced in the target text. The recommended code 401 further includes operators between the plurality of code fragments to be replaced in the target text. The recommended code is displayed below the target text, and the recommended code may be displayed in the same pop-up window.

In some embodiments, an association mark between the recommended code and the target text is further displayed on the code editing page, which facilitates the user to compare the recommended code with the target text. Continuing to refer to FIG. 4, an association mark 402 between the recommended code and the target text may be displayed.

In some embodiments, the target text is the original code in the code file, and the plurality of code fragments to be replaced in the target text are located in different code lines, and the recommended code is the replacement code for the target text. The step of displaying the first prompt information in response to the code editing operation for the code file may be implemented in the following manner: determining, in response to the code editing operation for the code file, a width occupied by the target text on the code editing page; when the width is less than or equal to a preset width, displaying the recommended code on the right of the target text, where the recommended code may be completely displayed on the right of the target text; and when the width is greater than the preset width, displaying the recommended code below the target text.

Herein, the code editing operation in this embodiment may be refer to the operation where the user modifies code in the code file. For the explanation and description of this operation, reference may be made to the relevant embodiments described above, which will not be repeated in this embodiment.

Herein, the preset width may be determined according to the width of a code visual area on the code editing page, and the code visual area is an area for displaying code. As an example, the preset width may be 70% of the width of the code visual area.

In order to improve the modification efficiency, one can modify the code file by completing the modification of a plurality of lines of code in one operation. At the same time, in the modification scenario, there may be a plurality of lines of code that need to be modified in the target text, and accordingly, the recommended code includes a plurality of lines. On this basis, the recommended code is prone to being obscured, resulting in the user ignoring the obscured content.

Therefore, through the above manner, the width occupied by the target text on the code editing page is detected. If the width occupied by the target text on the code editing page is relatively small (that is, less than or equal to the preset width), it represents that the probability of the recommended code being obscured when the target text and the recommended code are displayed side by side is very small, that is, the recommended code may be displayed on the right of the target text, so that the recommended code may be completely displayed on the right of the target text; if the width occupied by the target text on the code editing page is relatively large (that is, greater than the preset width), it represents that the probability of the recommended code being obscured when displayed on the right of the target text is relatively large, so the recommended code is selected to be displayed below the target text.

In some embodiments, in the modification scenario, in the case of displaying the recommended code on the right of the target text, the initial line of code of the recommended code is aligned with the initial line of code of the target text. FIG. 5 is a schematic diagram of a code editing page according to an embodiment of the present disclosure. Referring to FIG. 5, the first prompt information includes recommended code 502, an acceptance control 503 and a target natural language text 504. The recommended code 502 is displayed on the right of target text 501, and the recommended code 502 may be completely displayed on the right of the target text 501. The acceptance control 503 and the target natural language text 504 are displayed side by side on the right of the previous line code of the target text 501, and the initial line of code of the recommended code 502 is aligned with the initial line of code of the target text 501.

The acceptance control may refer to a control for applying the recommended code in the code file. The user may trigger an operation on the acceptance control through the electronic device to achieve the purpose of applying the recommended code in the code file. As an example, the user may click the acceptance control through the electronic device to achieve the purpose of applying the recommended code in the code file.

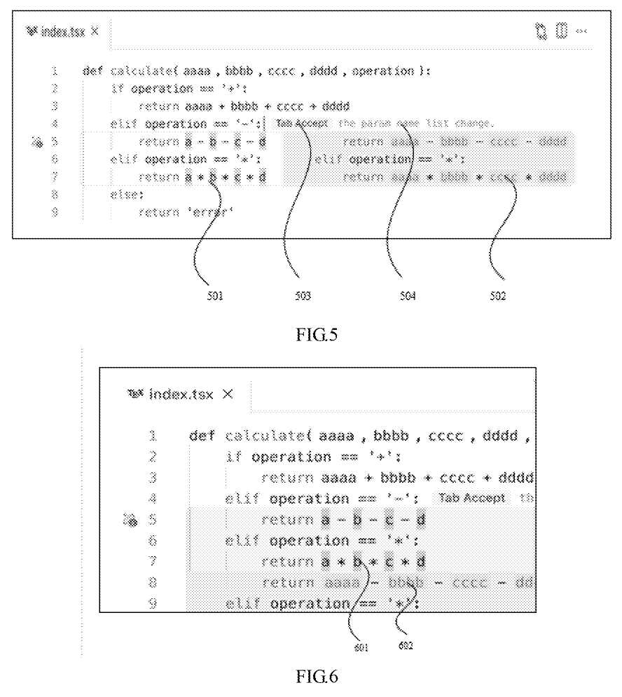

In some embodiments, in the modification scenario, in the case of displaying the recommended code below the target text, the recommended code is left-aligned with the target text. FIG. 6 is a schematic diagram of a code editing page according to an embodiment of the present disclosure. Referring to FIG. 6, the first prompt information includes recommended code 602, an acceptance control and a target natural language text. The recommended code 602 is displayed below target text 601, the acceptance control and the target natural language text are displayed on the right of the previous line code of the target text 601, and the recommended code 602 is left-aligned with the target text 601. For the explanation and description of the acceptance control in this embodiment, reference may be made to the relevant embodiments described above, which will not be repeated in this embodiment.

In some embodiments, the acceptance control and the target natural language text may be displayed side by side on the code line where the target text is located. Taking the continuation scenario as an example, continuing to refer to FIG. 2, an acceptance control 204 and the target natural language text 203 may be displayed side by side on the code line where the target text is located.

In some embodiments, in the case of displaying the recommended code below the target text, the above information display method may further include: determining that the recommended code is not completely displayed on the code editing page; and displaying a first control, where the first control is used to adjust the content displayed on the code editing page.

Herein, the first control may be a scroll bar, and the user may adjust the content displayed on the code editing page by dragging the scroll bar through the electronic device.

In this way, the user can be reminded to adjust the content displayed on the code editing page through the first control to view the complete recommended code.

In some embodiments, when the user applies the corresponding recommended code to a piece of original code in the code file, the visual focus is located at the position of the original code. In addition, if there is other original code in the code file that needs to be modified, in this case, a second control and second prompt information are displayed on the code line where the visual focus of the code editing page is located.

Next, the code editing operation may be a triggering operation on the second control, and it may be understood that the triggering operation is understood as an operation for adjusting the next piece of code that needs to be modified in the code file. The second prompt information is used to indicate a target jump position, and the target jump position is used to describe the position of the target text in the code file. Hereinafter, the code editing scenario corresponding to this embodiment is referred to as a multi-point modification scenario for short.

In this case, in the step of displaying the first prompt information in response to the code editing operation for the code file, the visual focus may jump to the target jump position in response to the triggering operation on the second control; and the first prompt information may be displayed according to the target jump position.

Herein, the triggering operation on the second control may be triggered by clicking the second control. Upon the triggering operation on the second control is performed, the state information of the line indication identifier corresponding to the original code where the current visual focus is located is in the jump state.

Herein, the second prompt information may be text information, and the second prompt information may be displayed on the second control. FIG. 7 is a schematic diagram of a code editing page according to an embodiment of the present disclosure. Referring to FIG. 7, second prompt information 701 is displayed on the second control.

Herein, the display position of the recommended code in the first prompt information may be determined according to the width occupied by the target text corresponding to the target jump position on the code editing page. For the manner of determining the display position of the recommended code according to the width, reference may be made to the relevant embodiments described above, which will not be repeated in this embodiment.

Herein, for the display positions of the acceptance control and the target natural language text in the first prompt information, reference may be made to the relevant embodiments described above, which will not be repeated in this embodiment.

Herein, for the explanation and description of the first prompt information, reference may be made to the relevant embodiments described above, which will not be repeated in this embodiment.

Through the above manner, the user may be provided with the target jump position, so that the user may perceive the jumped position.

In some embodiments, the above information display method may further include the following steps: determining a relative position between the original code of the code line where the second control is located and the target text; and determining to display the second prompt information according to the relative position.

As an example, the relative position may represent whether the original code of the code line where the second control is located and the target text belong to the same function, or whether they belong to the same file, etc.

Further, whether to display the second prompt information is determined according to whether the original code of the code line where the second control is located and the target text belong to the same function or the same file. For example, in the case of belonging to the same function, because the code involved in different code lines in the same function is related or may be displayed on the code editing page at the same time, the user may perceive the jump position, and thus the second prompt information may not be displayed. On the contrary, in the case of not belonging to the same function, it is difficult for the user to perceive the jump position, and thus the second prompt information may be displayed.

In some embodiments, in the multi-point modification scenario, the above display method may further include the following steps: determining that the initial line of code of the recommended code is not displayed on the code editing page; and highlighting the line indication identifier corresponding to the target text, where the line indication identifier is used to identify the position of the target text in the code file, and the highlighted line indication identifier is further used to prompt the user to adjust the content displayed on the code editing page.

As an example, the manner of highlighting may be to add a downward arrow to the line indication identifier.

As may be seen from the above, the line indication identifier is used to identify the position of the target text in the code file. Therefore, in the multi-point modification scenario, if it is determined that the recommended code is displayed below the target text, the initial line of code of the recommended code may not be displayed on the code editing page.

Therefore, the line indication identifier corresponding to the target text may be highlighted to prompt the user to view the relative recommended code.

In some embodiments, the step of displaying the first prompt information in response to the code editing operation for the code file may include: displaying a third control in response to a preset editing operation for the code file; triggering, in response to a triggering operation on the third control, the agent to generate the recommended code for the target text corresponding to the preset editing operation; and displaying the first prompt information.

In this embodiment, the preset editing operation may refer to the operation with complex intentions, such as an operation of the user adding comment text, an operation of defining a function, or an operation of defining an object. It may be understood that in the code editing scenario corresponding to the preset editing operation, the user desires to edit a long piece of code, and in order to reduce the waiting time of the user and avoid triggering the code editing operation multiple times, for example, in the multi-point modification scenario, the third control may be provided for the user to support the agent of the user to generate recommended code with a larger amount of code.

In this embodiment, the triggering operation on the third control may be a click operation on the third control.

In this embodiment, third prompt information may be displayed on the third control, and the third prompt information may indicate the purpose of triggering the third control.

Taking the preset editing operation being an operation of the user adding comment text as an example. FIG. 8 is a schematic diagram of a code editing page according to an embodiment of the present disclosure. Referring to FIG. 8, the user adds comment text 801 (that is, the target text) in the code file, and after that, a third control 802 is displayed on the code line where the comment text 801 is located, and third prompt information is displayed on the third control 802.

In this embodiment, for the display style of the target natural language text, reference may be made to the relevant embodiments described above, which will not be repeated in this embodiment.

In this embodiment, for the recommended code in the first prompt information, the first prompt information may be displayed in the following manner: displaying the recommended code character by character on the code editing page. In this embodiment, the agent may generate a large piece of code, and in order to increase the interestingness of interaction, the recommended code may be displayed character by character.

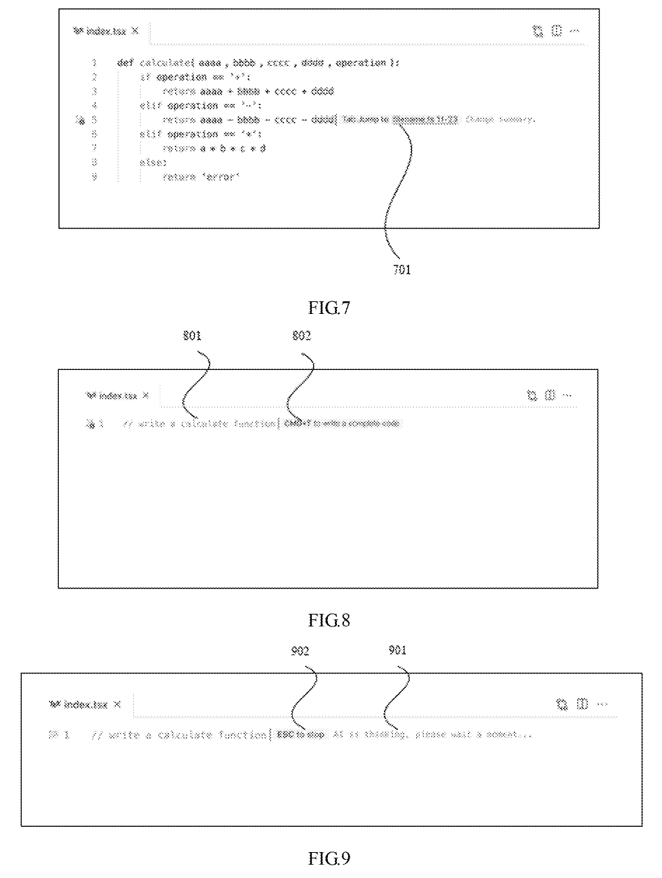

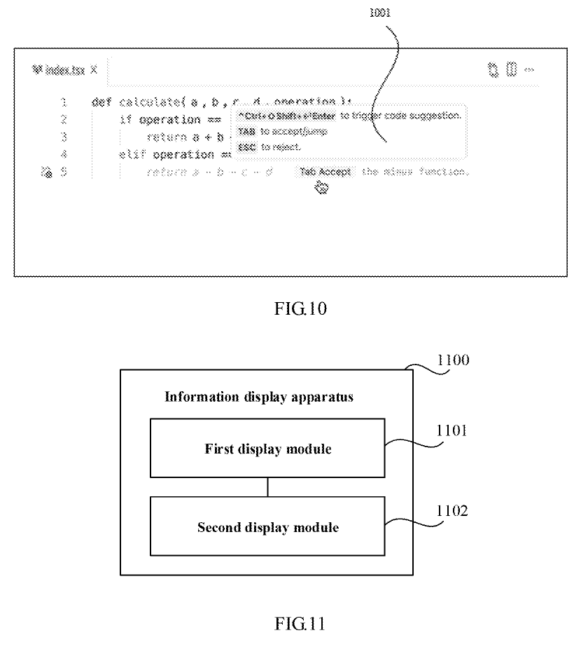

In this embodiment, in the process of generating the recommended code by the agent, the electronic device may further display fourth prompt information, and the fourth prompt information is used to represent that the agent is generating the recommended code. After the triggering operation on the third control is triggered, the agent starts to generate the recommended code, and then the fourth prompt information may be displayed, and the fourth prompt information may be displayed on the right of the target text. Referring to FIG. 9, by displaying fourth prompt information 901, the user is prompted that the agent is thinking about how to generate the recommended code.

In this embodiment, the information display method may further include: displaying a fourth control in the process of generating the recommended code by the agent; and ending the process of generating the recommended code by the agent in response to a triggering operation on the fourth control. As an example, it may be understood that after the user triggers the triggering operation on the third control, it represents that the agent starts to generate the recommended code, and then enters the process of generating the recommended code by the agent. Therefore, in response to triggering the triggering operation on the third control, the third control may be switched to the fourth control, and for the display position of the fourth control, reference may be made to the display position of the third control. For example, continuing to refer to FIG. 9, a fourth control 902 is displayed on the code line where the target text for the preset editing operation is located.

As an example, the triggering operation on the fourth control may be a click operation on the fourth control.

In some embodiments, the above information display method further includes: displaying a fifth control in response to a selecting operation on original code in the code file; and displaying a code reference corresponding to the original code in a dialogue input box of the agent in response to a triggering operation on the fifth control.

In this embodiment, the fifth control may be displayed after the initial line of code of the selected original code.

In this embodiment, the triggering operation on the fifth control may be a click operation on the fifth control.

Through the above manner, the code reference corresponding to the original code may be quickly input into the dialogue input box of the agent.

In some embodiments, the first target control is used to trigger a first target operation, corresponding prompt information is displayed on the first target control, and the prompt information displayed on the first target control is used to indicate a shortcut key for triggering the first target operation and purpose semantic information for triggering the first target control.

The shortcut key may be one key in the keyboard, or a combination of a plurality of keys. The efficiency of triggering the first target operation through the shortcut key is higher than the efficiency of triggering the first target operation through the first target control.

Herein, the prompt information displayed on the first target control may be text information.

Herein, the first target control is, for example, an acceptance control for applying the recommended code in the code file, a rejection control for rejecting the application of the recommended code in the code file, the second control, the third control, the fourth control, the fifth control, etc.

Continuing to refer to FIG. 9, prompt information is displayed on the fourth control 902, where the “ESC (Escape)” key in the prompt information is a shortcut key for triggering the operation corresponding to the fourth control, and the semantics of “to stop” in the prompt information is used to represent that the purpose of triggering the fourth control 902 is to end the process of generating the recommended code by the agent.

In some embodiments, the above information display method may further include: displaying fifth prompt information in response to a hover operation on the first target control, where the fifth prompt information is used to indicate a shortcut key for triggering a corresponding second target operation through a second target control.

Herein, the fifth prompt information may be text information.

Herein, for the explanation and description of the first target control, reference may be made to the relevant embodiments described above, which will not be repeated in this embodiment.

Herein, the second target control may be different from the first target control.

Herein, the second target operation is similar to the first target operation. The efficiency of triggering the second target operation through the shortcut key is higher than the efficiency of triggering the second target operation by clicking the second target control.

Herein, the fifth prompt information may be superimposed and displayed on the code editing page in the form of a pop-up window. Taking the first target control being a control for applying the recommended code in the code file as an example. Referring to FIG. 10, the user triggers the hover operation on the first target control through the electronic device, and the fifth prompt information is displayed in pop-up window 1001. The combination keys of Ctrl (control), shift (keyboard shift key) and Enter (enter key) may be shortcut keys for triggering the agent to generate the recommended code; the TAB (Tabulator) key may be a shortcut key for triggering the jump to the target jump position or a shortcut key for applying the recommended code in the code file; the ESC key may be a shortcut key for triggering the rejection of the application of the recommended code in the code file.

In some embodiments, the above information display method further includes the following steps: canceling displaying a line indication identifier in response to a cancel display operation on the line indication identifier.

Herein, the cancel display operation may refer to the operation of rejecting the application of the recommended code in the code file, and this operation may be achieved by clicking a control for rejecting the application of the recommended code in the code file, or may be achieved through a shortcut key, or by moving the visual focus.

It may be understood that the line indication identifier is to facilitate the user to view the position where the code is modified in the code file, and in the case of the user rejecting the modification, the corresponding line indication identifier may be canceled.

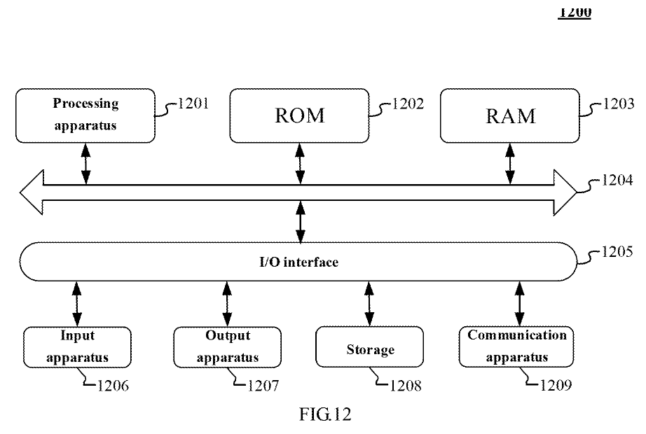

FIG. 11 is a block diagram of an information display apparatus according to an embodiment of the present disclosure. Referring to FIG. 11, the information display apparatus 1100 includes:

a first display module 1101, configured to display a code editing page, where the code editing page is used to edit a code file; and

a second display module 1102, configured to display first prompt information in response to a code editing operation for the code file, where the first prompt information includes recommended code for target text in the code file and a target natural language text corresponding to the recommended code, the recommended code is generated by an agent, and the target natural language text is used to represent a summary of the recommended code generated by the agent.

Optionally, the information display apparatus 1100 further includes:

a third display module, configured to display state information of a line indication identifier, where the line indication identifier is used to identify a position of the target text in the code file, and the state information is used to represent a current state of the recommended code.

Optionally, the target text is original code in the code file, and the target text is single-line code, the recommended code includes replacement fragments corresponding to a plurality of code fragments to be replaced in the target text, and the recommended code is displayed below the target text.

Optionally, the target text is original code in the code file, and a plurality of code fragments to be replaced in the target text are located on different code lines, the recommended code is replacement code for the target text, and the second display module 1102 includes:

a first response sub-module, configured to determine, in response to the code editing operation for the code file, a width occupied by the target text on the code editing page;

a first display sub-module, configured to display the recommended code on the right of the target text in a case where the width is less than or equal to a preset width, where the recommended code may be completely displayed on the right of the target text; and

a second display sub-module, configured to display the recommended code below the target text in a case where the width is greater than the preset width.

Optionally, in a case of displaying the recommended code on the right of the target text, an initial line of code of the recommended code is aligned with the initial line of code of the target text; in a case of displaying the recommended code below the target text, the recommended code is left-aligned with the target text.

Optionally, in the case of displaying the recommended code below the target text, the information display apparatus further includes 1100:

a first determination sub-module, configured to determine that the recommended code is not completely displayed on the code editing page; and

a third display sub-module, configured to display a first control, where the first control is used to adjust content displayed on the code editing page.

Optionally, a second control and second prompt information are displayed on a code line where a visual focus of the code editing page is located, the second prompt information is used to indicate a target jump position, the target jump position is used to describe the position of the target text in the code file, and the second display module 1102 includes:

a second response sub-module, configured to jump the visual focus to the target jump position in response to a triggering operation on the second control; and

a fourth display sub-module, configured to display the first prompt information according to the target jump position.

Optionally, the information display apparatus 1100 further includes:

a first determination module, configured to determine a relative position between original code of the code line where the second control is located and the target text; and

a second determination module, configured to determine to display the second prompt information according to the relative position.

Optionally, the information display apparatus 1100 further includes:

a third determination module, configured to determine that an initial line of code of the recommended code is not displayed on the code editing page; and

a fourth determination module, configured to highlight the line indication identifier corresponding to the target text, where the line indication identifier is used to identify the position of the target text in the code file, and the highlighted line indication identifier is further used to prompt a user to adjust the content displayed on the code editing page.

Optionally, the second display module 1102 includes:

a third response sub-module, configured to display a third control in response to a preset editing operation for the code file;

a fourth response sub-module, configured to trigger the agent to generate the recommended code for the target text corresponding to the preset editing operation in response to a triggering operation on the third control; and

a fifth display sub-module, configured to display the first prompt information.

Optionally, the fifth display sub-module is further configured to display the recommended code character by character on the code editing page.

Optionally, the information display apparatus 1100 further includes:

a fourth display module, configured to display fourth prompt information in a process of generating the recommended code by the agent, where the fourth prompt information is used to represent that the agent is generating the recommended code.

Optionally, the information display apparatus 1100 further includes:

a fifth display module, configured to display a fourth control in the process of generating the recommended code by the agent; and

an ending module, configured to end the process of generating the recommended code by the agent in response to a triggering operation on the fourth control.

Optionally, the information display apparatus 1100 further includes:

a sixth display module, configured to display a fifth control in response to a selecting operation on original code in the code file; and

a seventh display module, configured to display a code reference corresponding to the original code in a dialogue input box of the agent in response to a triggering operation on the fifth control.

Optionally, the first target control is used to trigger a first target operation, and the information display apparatus 1100 further includes:

an eighth display module, configured to display fifth prompt information in response to a hover operation on the first target control, where the fifth prompt information is used to indicate a shortcut key for triggering a corresponding second target operation through a second target control.

Optionally, the information display apparatus 1100 further includes:

a canceling module, configured to cancel displaying the line indication identifier in response to a cancel display operation on the line indication identifier.

For the implementations of various modules in the information display apparatus 1100, reference may be made to the above method embodiments, which will not be repeated in this embodiment.

An embodiment of the present disclosure further provides a computer-readable medium, having a computer program stored thereon, where the computer program, when executed by a processing apparatus, implements the steps of the above information display method.

An embodiment of the present disclosure further provides a computer program product, including a computer program, where the computer program, when executed by a processor, implements the steps of the above information display method.

An embodiment of the present disclosure further provides an electronic device, including:

a storage, having a computer program stored thereon; and

a processing apparatus, configured to execute the computer program in the storage to implement the steps of the above information display method.

Reference is made to FIG. 12 below, which illustrates a schematic structural diagram of an electronic device 1200 suitable for implementing the embodiments of the present disclosure. The terminal device in the embodiments of the present disclosure may include, but is not limited to, mobile terminals such as mobile phones, notebook computers, digital broadcast receivers, PDAs (personal digital assistants), tablet computers, PMPs (portable multimedia players), in-vehicle terminals (e.g., in-vehicle navigation terminals), etc., and fixed terminals such as digital TVs, desktop computers, etc. The electronic device shown in FIG. 6 is only an example, and should not impose any limitation on the function and scope of use of the embodiments of the present disclosure.

As shown in FIG. 6, the electronic device 600 may include a processing apparatus 601 (such as a central processing unit, a graphics processor, etc.), which may perform various appropriate actions and processes according to a program stored in a read-only memory (ROM) 602 or a program loaded from a storage 608 into a random-access memory (RAM) 603. The RAM 603 further stores various programs and data required for the operation of the electronic device 600. The processing apparatus 1201, the ROM 1202, and the RAM 1203 are connected to each other through a bus 1204. An input/output (I/O) interface 1205 is also connected to the bus 1204.

Usually, the following apparatuses may be connected to the I/O interface 1205: an input apparatus 1206 including, for example, a touch screen, a touchpad, a keyboard, a mouse, a camera, a microphone, an accelerometer, a gyroscope, etc.; an output apparatus 1207 including, for example, a liquid crystal display (LCD), a speaker, a vibrator, etc.; a storage 1208 including, for example, a magnetic tape, a hard disk, etc.; and a communication apparatus 1209. The communication apparatus 1209 may allow the electronic device 1200 to perform wireless or wired communication with other devices to exchange data. Although FIG. 12 shows the electronic device 1200 having various apparatuses, it should be understood that it is not required to implement or have all of the apparatuses shown. Alternatively, more or fewer apparatuses may be implemented or provided.

In particular, according to the embodiments of the present disclosure, the process described above with reference to the flowchart may be implemented as a computer software program. For example, an embodiment of the present disclosure includes a computer program product, which includes a computer program carried on a non-transitory computer-readable medium, where the computer program contains program code for performing the method shown in the flowchart. In such an embodiment, the computer program may be downloaded and installed from a network through the communication apparatus 1209, or installed from the storage 1208, or installed from the ROM 1202. When the computer program is executed by the processing apparatus 1201, the above-mentioned functions defined in the method of the embodiment of the present disclosure are executed.

It should be noted that the above computer-readable medium in the present disclosure may be a computer-readable signal medium, a computer-readable storage medium, or any combination of the two. The computer-readable storage medium may be, for example, but not limited to, an electrical, magnetic, optical, electromagnetic, infrared, or semiconductor system, apparatus or device, or any combination of the above. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium that contains or stores a program, and the program may be used by or in combination with an instruction execution system, apparatus or device. In the present disclosure, the computer-readable signal medium may include a data signal propagated in a baseband or as a part of a carrier wave, and computer-readable program code is carried therein. This propagated data signal may adopt multiple forms, including but not limited to an electromagnetic signal, an optical signal, or any suitable combination of the above. The computer-readable signal medium may also be any computer-readable medium other than the computer-readable storage medium, and the computer-readable signal medium may send, propagate or transmit the program used by or in combination with the instruction execution system, apparatus or device. The program code contained on the computer-readable medium may be transmitted by any suitable medium, including but not limited to: a wire, an optical cable, an RF (radio frequency), etc., or any suitable combination of the above.

In some implementations, the electronic device may communicate using any currently known or future developed network protocol, such as the HTTP (HyperText Transfer Protocol), and may be interconnected with any form or medium of digital data communication (for example, a communication network). Examples of the communication network include a local area network (“LAN”), a wide area network (“WAN”), an internet (for example, the Internet), a peer-to-peer network (for example, an Ad-Hoc network), and any network currently known or to be developed in the future.

The above computer-readable medium may be contained in the above electronic device, or it may exist alone without being assembled into the electronic device.

The above computer-readable medium carries one or more programs, which, when executed by the electronic device, cause the electronic device to: display a code editing page, where the code editing page is used to edit a code file; and display first prompt information in response to a code editing operation for the code file, where the first prompt information includes recommended code for target text in the code file and a target natural language text corresponding to the recommended code, the recommended code is generated by an agent, and the target natural language text is used to represent a summary of the recommended code generated by the agent.

The computer program code for performing the operations of the present disclosure may be written in one or more programming languages or a combination thereof, where the programming languages include but are not limited to object-oriented programming languages such as Java, Smalltalk, C++, and include conventional procedural programming languages such as “C” language or similar programming languages. The program code may be executed entirely on a user’s computer, partly executed on a user’s computer, executed as an independent software package, partly executed on a user’s computer and partly executed on a remote computer, or entirely executed on a remote computer or server. In the case of involving a remote computer, the remote computer may be connected to a user’s computer through any kind of network, including a local area network (LAN) or a wide area network (WAN), or it may be connected to an external computer (for example, connected through the Internet with the aid of an Internet service provider).

The flowcharts and block diagrams in the drawings illustrate the possibly implemented architectures, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the drawings. For example, two blocks shown in succession may actually be executed substantially in parallel, or they may sometimes be executed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The involved modules described in the embodiments of the present disclosure may be implemented by software or by hardware. Among them, the name of the module does not constitute a limitation on the module itself under certain circumstances.

The functions described herein above may be performed, at least in part, by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logical device (CPLD) and more.

In the context of the present disclosure, a machine-readable medium may be a tangible medium that may contain or store a program for use by or in combination with an instruction execution system, apparatus, or device. The machine-readable medium may be a machine-readable signal medium or a machine readable storage medium. The machine-readable medium may include, but is not limited to, an electronic, magnetic, optical, electromagnetic, infrared, or semi-conductive system, apparatus, or device, or any suitable combination of the above. More specific examples of the machine readable storage medium may include: an electrical connection based on one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

The above description is only preferred embodiments of the present disclosure and an explanation of the technical principles employed. Those skilled in the art should understand that the scope of disclosure involved in the present disclosure is not limited to the technical solutions formed by the specific combination of the above technical features, and should also cover other technical solutions formed by any combination of the above technical features or their equivalent features without departing from the above disclosed concept. For example, a technical solution formed by replacing the above features with technical features with similar functions disclosed in the present disclosure (but not limited to).

In addition, although the various operations are depicted in a particular order, this should not be understood as requiring the operations to be performed in the particular order shown or in a sequential order. Under certain circumstances, multitasking and parallel processing may be advantageous. Similarly, although the above discussion contains a number of specific implementation details, these should not be interpreted as limiting the scope of the present disclosure. Certain features that are described in the context of separate embodiments may also be implemented in combination in a single embodiment. Conversely, various features described in the context of a single embodiment may also be implemented in multiple embodiments individually or in any suitable sub-combination.

Although the subject matter has been described in language specific to structural features and/or logical actions of the method, it should be understood that the subject matter defined in the appended claims is not necessarily limited to the specific features or actions described above. Conversely, the specific features and actions described above are only example forms for implementing the claims. Regarding the apparatuses in the above embodiments, the specific manner in which each module performs an operation has been described in detail in the embodiments relating to the method, and will not be detailed herein.

We claim:

1. An information display method, comprising:
displaying a code editing page, wherein the code editing page is used to edit a code file; and
displaying first prompt information in response to a code editing operation for the code file, wherein the first prompt information comprises recommended code for target text in the code file and a target natural language text corresponding to the recommended code, the recommended code is generated by an agent, and the target natural language text is used to represent a summary of the recommended code generated by the agent.

2. The method of claim 1, further comprising:
displaying state information of a line indication identifier, wherein the line indication identifier is used to identify a position of the target text in the code file, and the state information is used to represent a current state of the recommended code.

3. The method of claim 1, wherein the target text is original code in the code file, and the target text is single-line code, the recommended code comprises replacement fragments corresponding to a plurality of code fragments to be replaced in the target text, and the recommended code is displayed below the target text.

4. The method of claim 1, wherein the target text is original code in the code file, and a plurality of code fragments to be replaced in the target text are located on different code lines, the recommended code is replacement code for the target text, and wherein displaying the first prompt information in response to the code editing operation for the code file comprises:
determining, in response to the code editing operation for the code file, a width occupied by the target text on the code editing page;
displaying, in a case that the width is less than or equal to a preset width, the recommended code on a right of the target text, wherein the recommended code is completely displayed on the right of the target text; and
displaying, in a case wherein the width is greater than the preset width, the recommended code below the target text.

5. The method of claim 4, wherein in a case of displaying the recommended code on the right of the target text, an initial line of code of the recommended code is aligned with an initial line of code of the target text; and wherein in a case of displaying the recommended code below the target text, the recommended code is left-aligned with the target text.

6. The method of claim 4, wherein in the case of displaying the recommended code below the target text, the method further comprises:
determining that the recommended code is not completely displayed on the code editing page; and
displaying a first control, wherein the first control is used to adjust content displayed on the code editing page.

7. The method of claim 1, wherein a second control and second prompt information are displayed on a code line where a visual focus of the code editing page is located, the second prompt information is used to indicate a target jump position, the target jump position is used to describe the position of the target text in the code file, and wherein displaying the first prompt information in response to the code editing operation for the code file comprises:
jumping the visual focus to the target jump position in response to a triggering operation on the second control; and
displaying the first prompt information according to the target jump position.

8. The method of claim 7, further comprising:
determining a relative position between original code of the code line where the second control is located and the target text; and
determining to display the second prompt information according to the relative position.

9. The method of claim 7, further comprising:
determining that the initial line of code of the recommended code is not displayed on the code editing page; and
highlighting the line indication identifier corresponding to the target text, wherein the line indication identifier is used to identify the position of the target text in the code file, and the highlighted line indication identifier is further used to prompt a user to adjust the content displayed on the code editing page.

10. The method of claim 1, wherein displaying the first prompt information in response to the code editing operation for the code file comprises:
displaying a third control in response to a preset editing operation for the code file;
triggering, in response to a triggering operation on the third control, the agent to generate the recommended code for the target text corresponding to the preset editing operation; and
displaying the first prompt information.

11. The method of claim 10, wherein displaying the first prompt information comprises:
displaying the recommended code character by character on the code editing page.

12. The method of claim 11, further comprising:
displaying fourth prompt information in a process of generating the recommended code by the agent, wherein the fourth prompt information is used to represent that the agent is generating the recommended code.

13. The method of claim 10, further comprising:
displaying a fourth control in the process of generating the recommended code by the agent; and
ending the process of generating the recommended code by the agent in response to a triggering operation on the fourth control.

14. The method of claim 1, further comprising:
displaying a fifth control in response to a selecting operation on original code in the code file; and
displaying, in response to a triggering operation on the fifth control, a code reference corresponding to the original code in a dialogue input box of the agent.

15. The method of claim 1, wherein a first target control is used to trigger a first target operation, and wherein the method further comprises:
displaying fifth prompt information in response to a hover operation on the first target control, wherein the fifth prompt information is used to indicate a shortcut key for triggering a corresponding second target operation through a second target control.

16. The method of claim 2, further comprising:
canceling displaying the line indication identifier in response to a cancel display operation on the line indication identifier.

17. A non-transitory computer-readable medium, having a computer program stored thereon, wherein the computer program, when executed by a processor, causes the processor to:
display a code editing page, wherein the code editing page is used to edit a code file; and
display first prompt information in response to a code editing operation for the code file, wherein the first prompt information comprises recommended code for target text in the code file and a target natural language text corresponding to the recommended code, the recommended code is generated by an agent, and the target natural language text is used to represent a summary of the recommended code generated by the agent.

18. The non-transitory computer-readable medium of claim 17, wherein the computer program, when executed by a processor, further causes the processor to:
display state information of a line indication identifier, wherein the line indication identifier is used to identify a position of the target text in the code file, and the state information is used to represent a current state of the recommended code.

19. An electronic device, comprising:
a storage, having a computer program stored thereon; and
a processor, configured to execute the computer program in the storage to:
display a code editing page, wherein the code editing page is used to edit a code file; and
display first prompt information in response to a code editing operation for the code file, wherein the first prompt information comprises recommended code for target text in the code file and a target natural language text corresponding to the recommended code, the recommended code is generated by an agent, and the target natural language text is used to represent a summary of the recommended code generated by the agent.

20. The electronic device of claim 19, wherein the target text is original code in the code file, and a plurality of code fragments to be replaced in the target text are located on different code lines, the recommended code is replacement code for the target text, and wherein the electronic device configured to display the first prompt information in response to the code editing operation for the code file is further configured to execute the computer program in the storage to:
determine, in response to the code editing operation for the code file, a width occupied by the target text on the code editing page;
display, in a case that the width is less than or equal to a preset width, the recommended code on a right of the target text, wherein the recommended code is completely displayed on the right of the target text; and
display, in a case wherein the width is greater than the preset width, the recommended code below the target text.
